(19) United States
(12) Patent Application Publication
(10) Pub. No.: US 2012/0071094 A1
(43) Pub. Date: Mar. 22, 2012

(54) Communication through a composite barrier

(76) Inventors: Brendan Peter Hyland, Edinburgh (GB); Mark Volanthen, Hampshire (GB); Gareth Conway, Keady (GB); Mark Rhodes, West Lothian (GB)

(21) Appl. No.: 12/956,235

(22) Filed: Nov. 30, 2010

Related U.S. Application Data
(60) Provisional application No. 61/384,651, filed on Sep. 20, 2010.

(51) Int. Cl. H04B 7/00

(52) U.S. Cl. 455/41.2

(57) ABSTRACT

The present invention discloses a system that implements data communications through a barrier composed of composite, layered materials. A low frequency electromagnetic signal is used to achieve acceptable channel losses as the signal passes through a composite barrier which may comprise materials with variable conductivity and/or permeability.

### CROSS-REFERENCE OF RELATED APPLICATION

This application claims priority to U.S. Provisional Patent Application No. 61/384,651, filed Sep. 20, 2010, entitled “Communication Through a Composite Barrier,” by WFS Technologies Ltd, and is hereby incorporated herein by reference.

### FIELD OF USE

The present invention relates to the field of data communications through a barrier composed of composite, layered materials. More particularly, the present invention relates to the field of data communication through a barrier composed of composite, layered materials such as provided in a freight or intermodal container.

### DESCRIPTION OF THE RELATED ART

Wireless communications systems have found applications in a diverse range of systems. One area that is particularly challenging for wireless radio systems is in the provision of a communications channel through barriers, particularly if part of the barrier construction is metallic. The communications channel is further complicated if the barrier comprises a composite construction where the various layers interact with electromagnetic fields differently.

Freight transport containers are commonly used to transport temperature sensitive and perishable goods long distances. Such distances may be over land and/or over sea. Monitoring of internal environmental conditions and the provision of near-real time information such as internal temperature is particularly beneficial in the field of logistics and supply chain management. However, communicating sensor data through a wall of a container for receiving, generally, by personnel outside the enclosed container presents several problems. Drilling holes for example in any wall of the container to support data communication cabling would compromise the thermal insulation of the container thus impacting the condition of the transported goods. Provision for cabling may more readily be provided during manufacture of a container in contrast to the challenging task of retrospective fitting to existing containers. Additionally and typically, freight containers are typically leased for each journey and so permanent fitting of monitoring equipment required by an individual client may not be practical or desirable. Furthermore, freight containers are typically packed by unskilled dock and warehouse workers who may not take care of specialized placed devices. In these cases, a wireless means of communication through for example the wall of the container would allow deployment of a temporary monitoring system that could be recovered for re-use at the end of a journey.

While some systems have been proposed for communication through steel or metallic bulkheads, the refrigerated container wall can be described as a composite wall or barrier and as such presents a unique communications challenge due to its particular construction. Typically, steel interior and exterior walls are utilized to provide structural strength and which sandwich a thicker internal layer of thermal insulation material. Current coupled magnetic flux based systems will not however deliver acceptable performance through the composite wall or barrier material of an insulated container because the thermal insulation layer has very low magnetic permeability and so provides too high a magnetic reluctance in the magnetic circuit linking primary to secondary coils.

Clearly therefore, reliable communication through a composite barrier material would find application in a number of areas such as for example communication through the insulated wall of a freight container.

In one example, a freight container may be of a layered wall construction. Typically, the layers that are used to construct the wall structure may have the following composition and thickness: 1.8 mm steel, 95 mm polyurethane foam insulation and 0.8 mm steel. Further, a commonly found freight container might be 40 foot (12.2 m) in length such that the overall outer dimensions are 12.2 m×2.4 m×2.9 m. Generally however, insulated freight containers are constructed to a common standard and typically exhibit at least an inner or outer metal walls.

There is therefore a need for a robust and reliable way to wirelessly communicate real-time data or near real-time data from a temporary arranged sensor unit located inside a freight container to a unit located outside the container. The difficulty lies in the impenetrability of the metal skin of the freight container by traditional wireless methods, given that physical breach or modification of the freight container is not desired.

A means of providing wireless communications through a temperature controlled insulated container wall would be advantageous for monitoring the interior environment during transport of goods such as for example perishable goods.

### SUMMARY OF THE INVENTION

In one aspect, the present invention relates to a through barrier communications system suitable for data communications through a barrier such as a freight container. The system comprises at least one of a primary coil and primary coupling core and at least one of a secondary coil and secondary coupling core for forming a magnetic flux circuit. The at least one of primary and secondary coil passes electromagnetic signals with acceptable losses from one side of a barrier to another by means of low frequency electromagnetic signals and said composite barrier comprises at least one electrically conductive layer and at least one electrically insulating layer. The electrically conductive layer of the through barrier communication system of the present invention has a conductivity greater than 2 S/m² and the electrically insulating layer has a conductivity less than 0.001 S/m². The electromagnetic signals comprise a carrier signal that is modulated to represent data and said electromagnetic signals received in the secondary coil are de-modulated to recover transmitted data. Furthermore, said electromagnetic signals typically have an alternating frequency of less than 5 kHz.

In one embodiment, the at least one of the primary coupling coil and/or secondary coupling coil of the through barrier communications system of the present invention is arranged with its axis of symmetry orthogonal to the plane of the barrier.

In a second embodiment, the at least one of the primary coupling coil and/or secondary coupling coil is mounted co-centric around an elongate protrusion access point of a cable feed-through flange. Furthermore, said access point comprises a cable gland feeding at least one cable from said first side to said second side of composite barrier. The at least one of primary coupling coil is optionally separated and aligned mostly congruent with the at least one of secondary coupling coil. Moreover, said access point comprises a flange of an electrically non-conductive material.

In the case of the second embodiment, the at least one primary core and secondary core comprises at least two sub-sections. The at least said two sub-sections of at least one of primary core and at least one of secondary core can be assembled forming a unitary core. In use, assembled at least two sub-sections of at least one of primary core and/or secondary core are arranged co-concentric around access point so that a protruding cable of said access point passes through the centre axis of said at least one coupling core. Optionally, at least one of said primary coupling core and second secondary core is formed of a material having a high magnetic permeability and said at least one of said primary coupling core and second secondary core may be a toroidal core. Preferably, at least one of said primary coil and secondary coil is formed over an air core. In use, said electromagnetic signals are passed from said primary coil to said secondary coil via said flange. Preferably, the transmission between said primary coil to secondary coil is bi-directional.

In another aspect of the present invention, said data is relayed to a data network system such as GSM, Bluetooth®, ZigBee®, GPS, RFID, or a combination thereof. In yet another aspect of the present invention, said data may be relayed to other sensors. Preferably, said data is any one of control signaling, audio, video, power, sensory.

In yet another aspect of the present invention, said composite barrier may comprise a first and a second metallic layer separated by a non-metallic layer. In the case of a single metal wall layer with insulation and internal layers constructed of a non-conductive material the presently disclosed communication technique will provide particularly good results. In particular, in the case of a construction of a single metallic barrier, the insulation material prevents close contact with the metallic barrier at one side of the wall so reducing the efficiency of flux coupling methods to such an extent that it becomes impractical.

Furthermore, said composite barriers may be a freight container, an aircraft hull, or a surfboard hull.

Embodiments of the present invention will now be described in detail with reference to the accompanying figures in which:

### BRIEF DESCRIPTION OF THE DRAWINGS

FIG. 1 shows a block diagram of a communications system of the present invention;

FIG. 2 shows a modem communications system communicating through an example container insulating wall;

FIG. 3 shows a simplified side view of a system for wireless communications through a composite barrier of a freight container according to a first embodiment the present invention;

FIG. 4 shows a simplified front view of a first transducer according to the system for wireless communications through a composite barrier depicted in FIG. 1;

FIG. 5 shows a simplified front view of a first transducer according to the system for wireless communications through a composite barrier depicted in FIG. 1 comprising a pair of associated transducer coils;

FIG. 6 shows a simplified schematic view of a system for wireless communications through a composite barrier according to another embodiment of the present invention comprising a transmitter a receiver and first and second inductive transducers;

FIG. 7 shows a simplified schematic view drawing of a system for wireless communications through a composite barrier according to another embodiment of the present invention comprising a transmitter a receiver and an inductive transducer.

### DETAILED DESCRIPTION OF THE PREFERRED EMBODIMENTS

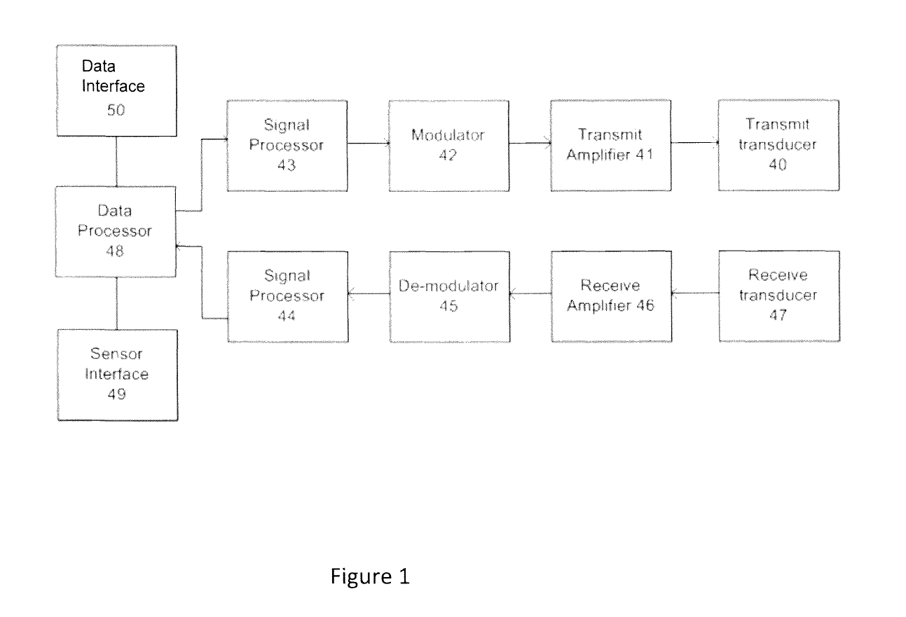

FIG. 1 is a block diagram of a through barrier communications system of the present invention. The system of the present invention implements data communications through a barrier composed of composite, layered materials. A low frequency electromagnetic signal is used to achieve acceptable channel losses as the signal passes through a composite barrier which may comprise materials with variable conductivity and/or permeability. The barrier may for example, be the wall of an insulated freight container, or aircraft hull, surfboard hull or other composite structures. Preferably, an electrically conductive layer has a conductivity greater than 2 S/m². Further preferably, an electrically insulating layer has a conductivity less than 0.001 S/m².

The receive transducer 47 of FIG. 1 receives a modulated signal which is amplified by receive amplifier 46. De-modulator 45 mixes the received signal to base band and detects symbol transitions. The signal is then passed to signal processor 44 which processes the received signal to extract data. Data is then passed to data processor 48 which in turn forwards the data to control interface 50. Sensor interface 49 receives data from deployed sensors which is forwarded to data processor 48. Data is then passed to signal processor 43 which generates a modulated signal which is modulated onto a carrier signal by modulator 42. Transmit amplifier 41 then generates the desired signal amplitude required by transmit transducer 40. Where required, data is passed on to further equipment through data interface 50. For example, data interface 50 may provide onward transmission of data and used to relay data between adjacent containers. Typically, containers may be adjacently stacked on-board a dedicated cargo vessel for transportation by sea. Alternatively, containers may be adjacently stacked in a dedicated container terminal (e.g. container port and/or logistic distribution center). Further, internal data (for example temperature) of a first stacked bottom container may be transmitted externally by a Bluetooth® link or other data link to a second container through a barrier system and in this way relayed between containers to a desired location. This data network system could provide data access for a number of containers at a convenient location.

Preferably, a bi-directional system can be implemented by integrating two of the systems as presently described and multiplexing through time division, frequency division or any of the commonly used communications multiplexing techniques. Data can be communicated from outside the barrier to inside. In some embodiments of the present invention, the external modem may interface to a second wireless data transmission system so that commands and data may originate remotely for relay into the container. Control signals may be used to regulate equipment inside the container.

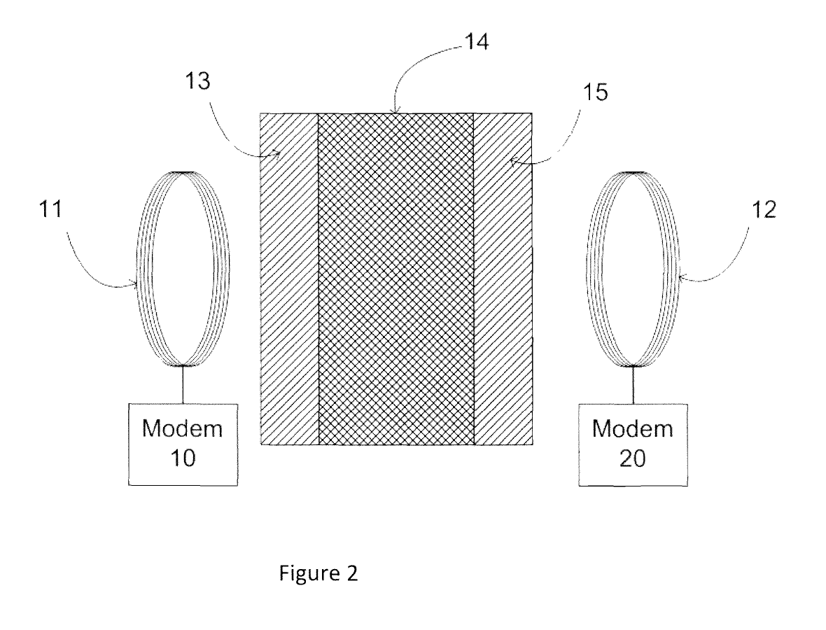

FIG. 2 shows a modem communications system communicating through an example container insulating wall according to an embodiment of the present invention. Modem 10 produces a low frequency modulated current in loop 11 that is representative of the transmitted data. A time varying magnetic field produced by the alternating current in loop 11 transverses along and passes through first metallic layer 13, through polyurethane thermal insulation layer 14 and through a second metallic layer 15. The time variant magnetic flux passes through loop 12 and induces an electric potential across the loop which is de-modulated by modem 20 to reproduce the transmitted data at the receiver. Flux leakage through the metal layers is proportional to frequency. As the frequency increases, current is confined to the surface of the metal layers 13, 15.

In conductive media such as metal, the current forms current loops known as eddy currents which generate opposing magnetic fields and contribute to the losses in the metal. However, depending on the thickness of the metal and the operating frequency, there may be some flux leakage through the metal layers which forms closed field loops in the receiver. If the voltage induced in the receiver coil, which is proportional to the flux density through the centre of the receiver coil, is above the noise floor of the receiver system then a communication link is established. Metallic layers 13, 15, or more generally, electrically conducting layers, strongly attenuate electromagnetic signals as they pass through them. Since, generally, attenuation increases with the frequency of the electromagnetic signal it is preferable to use relatively low frequency signals. For example, in some systems a carrier frequency below 5 kHz may be used. In one example embodiment the data signal modulates a 3 kHz carrier signal and transmits data at 100 bps. FIG. 2 illustrates a co-axial relative positioning of loops on either side of a barrier and arranged with their planes parallel to the surface of the barrier.

To achieve maximum performance, the receive circuitry and antenna must be extremely sensitive and operate under low noise conditions. Likewise, the transmit circuitry must be optimized to deliver a large magnetic field, thus maximizing the available link budget. The frequency at which the field is detectable by the receiver, governs the bandwidth of the system. Additionally, various modulation schemes can be applied to maximize the data throughput, but ultimately it is governed by the signal strength to noise ratio. For example, higher order modulation techniques may be utilized to achieve greater data transmission rates over a given bandwidth and complex modulation schemes such as 64-QAM may be used in deployments where a sufficiently high signal to noise ratio is achieved. Dispersion may also present problems for wide band systems. Equalizers may be needed to mitigate phase distortion.

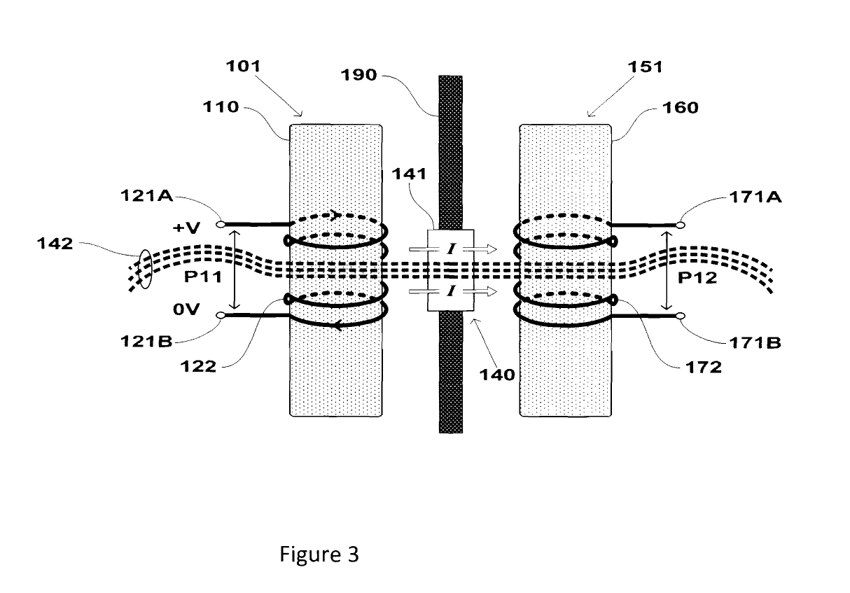

FIG. 3 shows a simplified schematic side view of a system for wireless communications through a composite barrier 190 according to an embodiment of the present invention. The generic term ‘communications’ here and elsewhere implicitly refers to any or all of: transmission and/or reception of communications signals, transmission and/or reception of control signals and transmission and/or reception of data. Here the communication system makes use of an existing penetrating feature to achieve lower transmission losses through the barrier.

The system of FIG. 3 comprises a first transducer 101 comprising a first transducer coil 122 formed over for example a magnetic permeable toroidal core 110. First transducer coil 122 is wound of electrically conductive wire having an electrically insulating outer coating. First transducer coil may however be formed over an air core, plastic core, ceramic core, or other non-magnetic forms. First transducer coil 122 comprises input terminals 121A, 121B across which a voltage differential V may be applied. First transducer 101 is arranged so that the plane of toroidal core 110 is with its axis of symmetry orthogonal to the plane of barrier 190. Preferably, during use, one side of toroidal core 101 is arranged so that it is close to or flush against barrier 190 and so that the centre axis of toroidal core 110 intersects the centre point of a feed through 140. In other words, core 110 is mounted co-centric around an elongate protrusion access point of cable feed-through 140. Feed through 140 comprises flange 141 and cable bundle 142 which penetrates flange 141.

A second transducer 151 is positioned on the opposite side of composite barrier 190, and is aligned mostly congruent with first transducer 101. Second transducer 151 comprises a second transducer coil 172 formed over for example a toroidal core 160. Second transducer coil 172 may however be formed over an air core, plastic core, ceramic core, or other non-magnetic forms. Second transducer coil 172 comprises output terminals 171A, 171B. Preferably, toroidal core 160 is with its axis of symmetry orthogonal to the plane of barrier 190.

In the case where toroidal cores 110, 160 are utilized, they may be formed from a wide range of materials. A material having a high relative magnetic permeability is preferable. One specific material which may be used for magnetic cores 110, 160 is ferrite. Ferrite is commonly used for transformer and inductor cores because of its high magnetic permeability. Ferrite is suitable for use in applications requiring the coupling of magnetic fields having frequencies ranging from a lower extreme of approximately 1 Hz, to an upper extreme of approximately 100 MHz.

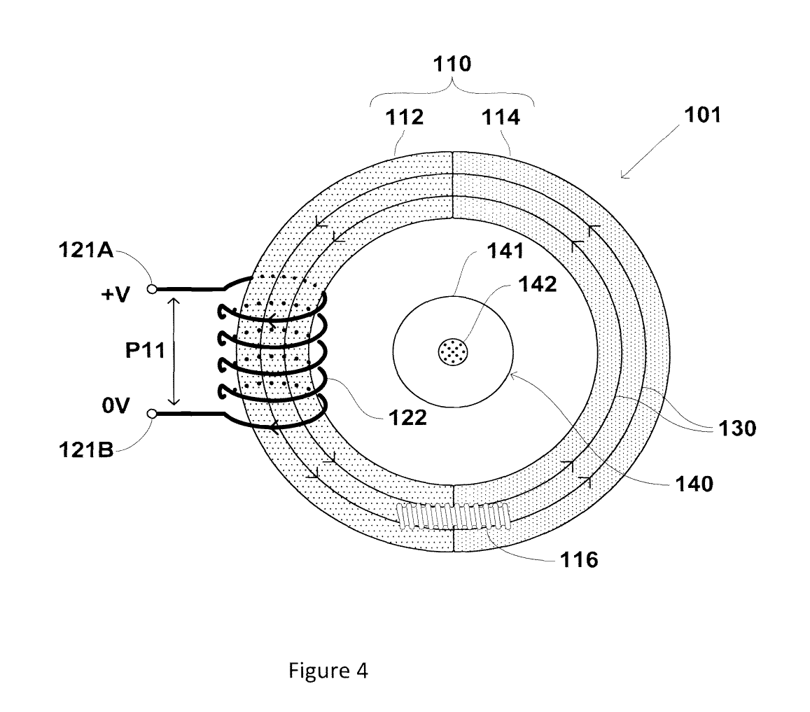

FIG. 4 shows a simplified front view of first transducer 101 according to the system for wireless communications through a composite barrier embodying the present invention and depicted in FIG. 3.

In a second embodiment of the present invention, toroidal core 110, may be split into two identical sub-sections 112, 114. Toroidal core 110 may be split into two sections to allow easy fitment around cable feed-through flange 140. Toroidal core 110 may be assembled by affixing each section 112, 114 to each other forming a unitary core. Assembly may be by means of a threaded element and screw mating with each other 116. The two sections 112, 114 of toroidal core 110 may alternatively be fixed to each other by an alternative mechanical means and/or other means known to persons skilled in the art. Although not depicted in the present figure, toroidal core 160 may also be split into two identical sub-sections. Toroidal core may be assembled by affixing each section to each other forming a unitary core by means of a threaded element and screw mating with each other. Assembled sections of toroidal core 110, 160 are arranged co-centric around feed-through flange 140 such that a protruding cable passes through centre axis of core 110, 160.

When assembled, transducer 101 fits around a seal material 140 of composite barrier 190 as represented in the simplified schematic view of FIG. 3. Preferably seal 140 comprising flange 141 is made of electrically non-conductive material. Seal 140 comprises flange 141 and cable bundle 142 which penetrates flange 141. The split structure of toroidal core 110 comprising sections 112, 114 enables first transducer 101 to be assembled so that it fits around an existing cable which protrudes from cable gland or seal 140 and which penetrates composite barrier 190. Thus, first transducer 101 can be deployed around seal 140 without any modification thereof, without any modification of the cable bundle 142 passing through seal 140 or without any modification of the composite barrier 190.

First transducer coil 122 is wound around either one of the two sections 112, 114 of for example toroidal core 110 and is formed of electrically conductive wire having an insulating coating. First transducer and/or second transducer may however be formed over an air core, plastic core, ceramic core, or other non-magnetic forms. A current entering first transducer coil 122 at terminal 121A, and exiting at terminal 121B, induces a magnetic field in toroidal core 110 which follows the path and direction of magnetic field lines 130.

Cable bundle 142 may comprise several cables, but nonetheless occupies only a portion of the area occupied by flange 141 of seal 140. Ideally, cable bundle 142 comprises one or more screened cables.

In use, an electrical signal is fed to port P11 of first transducer 101. The electrical signal induces a circular magnetic field in first transducer core 110, which induces a corresponding electrical signal in the screen of at least one of cable bundle 142. The current flowing in the screen of at least one of cable bundle 142 induces a circular magnetic field in second transducer core 160 as represented in the simplified schematic view of FIG. 3. This, in turn, induces a current in second transducer coil 172, which may be detected using conventional electronic communications equipment. Input electrical signals may have carrier frequencies ranging from 1 Hz to 10 MHz.

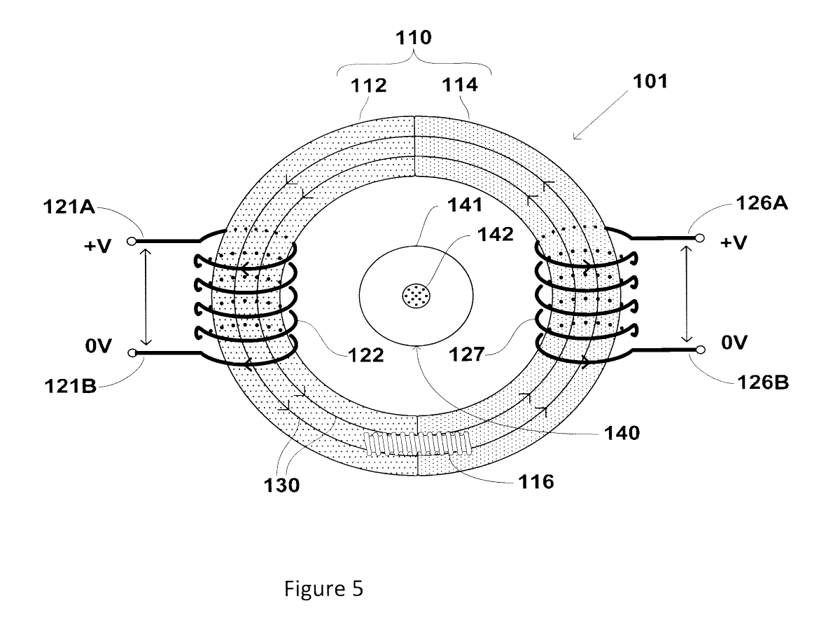

FIG. 5 shows a simplified schematic front view of first transducer 101 according to the system for wireless communications through a composite barrier depicted in FIG. 3 comprising a pair of associated transducer coils.

The transducer depicted in FIG. 5 is identical to that of FIG. 4, except that a pair of associated transducer coils 122, 127 is provided instead of the single transducer coil 122 for the transducer shown in FIG. 4. Transducer coil 127 comprises input terminals 126A, 126B, across which a voltage differential V may be applied. In use, electrical signals are fed to terminals 121A, 121B and 126A, 126B so that magnetic field lines 130 produced by each of associated transducer coils 122, 127 are aligned.

Passing electrical currents through of a pair of transducer coils 122, 127 as shown in FIG. 5 provides an increased magnetic field inside toroidal core 110, when compared with a transducer comprising only a single coil 122 as represented in the simplified schematic view of FIG. 4.

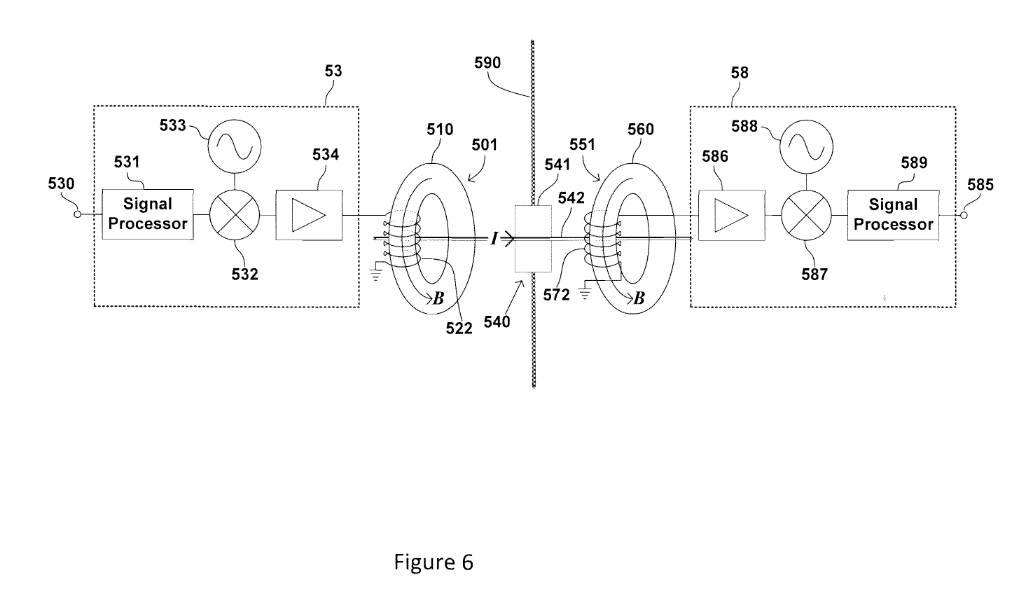

FIG. 6 shows a simplified schematic view of a system for wireless communications through a composite barrier according to another embodiment of the present invention comprising a transmitter 53 a receiver 58 and respective first and second inductive transducers 501, 551. The system further comprises a seal 540, having a flange 541 of an electrically non-conductive material, and a cable bundle or metallic pipe 542 passing through pressure hull gland 540. Inductive transducer 501 is electrically connected to transmitter 53 and inductive transducer 551 is electrically connected receiver 58.

Transmitter 53 comprises an input port 530. Input signals fed to input port 530 may comprise any of voice or video signals, images, control signals or data. A suitable input device (not shown), which provides voice signals, video signals, images, control signals or data signals, as appropriate is connected to input port 530. Such input devices are well known to those skilled in the art.

During operation, an input signal is passed to processor 531 where it is encoded and modulated for transmission in accordance with the transmission system to be used. The encoded signal is output from processor 531, where it is fed to mixer 532, to be mixed with a signal generated by local oscillator 533 for frequency up-conversion. The frequency up-converted signal is then amplified by amplifier 534 and fed to first transducer 501.

First transducer 501 comprises annular core 510, and associated coil 522. Second transducer 551 comprises annular core 560, and associated coil 572. First transducer 501 is placed near or adjacent to composite barrier 590, and is assembled around seal 540, so that a cable 542 protruding from seal 540 threads the centre of annular core 510. The input signal fed to transducer 501 induces an alternating magnetic field in core 510, which, in turn, induces an alternating current in one or more of the cables in cable bundle 542.

The alternating current induced in cable bundle 542 induces a corresponding signal in second transducer 551 which is received by receiver 58. Thus, transmission and reception of the input signal is by means of electrical coupling of the signal in one or more of the cables in cable bundle 542 and is via a path through seal 540.

The signal which is received by transducer 551, is passed to amplifier 586. The amplified signal is fed to mixer 587, to be mixed with another signal generated by local oscillator 588 for frequency down conversion. The down converted data signal is then passed to processor 589 where it is demodulated and decoded and output at output port 685.

Receiver 58 also comprises an output port 585. A suitable output device (not shown), which outputs voice signals, video signals, images, control signals or data signals, as appropriate and as would be known to a person skilled in the art, is connected to output port 655. Output signals might comprise any of voice or video signals, images, control signals or data.

Input and output devices for use with the embodiment of the present invention depicted in FIG. 6 might include, microphones, cameras, video cameras, personal computers, communications handsets, or any device which provides an input and/or output electrical signal.

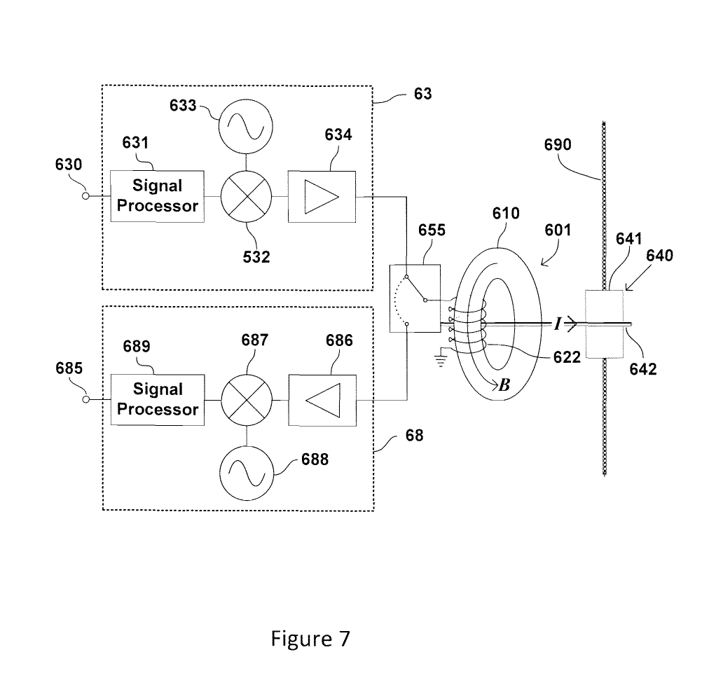

FIG. 7 shows a simplified schematic view of a system for wireless communications through a composite barrier according to yet another embodiment of the present invention comprising a transmitter 63 a receiver 68 and an inductive transducer 601. Inductive transducer 601 is connected to transmitter 63 and receiver 68 via switch 655. In use, switch 655 is set to connect transmitter 63 with transducer 601 when signals are to be transmitter, and is set to connect receiver 64 to transducer 601 when signals are to be received.

Transmitter 63 comprises an input port 630. Input signals fed to input port 630 may comprise any of voice or video signals, images, control signals or data. A suitable input device (not shown), which provides voice signals, video signals, images, control signals or data signals, as appropriate is connected to input port 630. Such input devices are well known to those skilled in the art.

During operation, the input signal is passed to processor 631 where it is encoded and modulated for transmission in accordance with the transmission system to be used. The encoded signal is output from processor 631, where it is fed to mixer 632, to be mixed with a signal generated by local oscillator 633 for frequency up-conversion. The frequency up-converted signal is then amplified by amplifier 634 and fed to first transducer 601 via switch 655.

Receiver 68 comprises an output port 685. Output signals might comprise any of voice or video signals, images, control signals or data according to the signal received by transducer 601. A suitable output device (not shown), which outputs voice signals, video signals, images, control signals or data signals, as appropriate and as would be known to a person skilled in the art, is connected to output port 685.

During operation, a signal is received by transducer 601, is passed to amplifier 686 via switch 655 where it is amplified. The amplified signal is fed to mixer 687, to be mixed with a signal generated by local oscillator 688 for frequency down conversion. The down converted data signal is then passed to processor 689 where it is demodulated and decoded and output at output port 685.

First transducer 601 comprises annular core 610, and associated coil 622. During operation, first transducer 601 is placed near or adjacent composite barrier 690, and is assembled around seal 640, so that cable 642 protruding from seal 640 threads the centre of annular core 610. The alternating signals fed to transducer 610 induce alternating magnetic fields in core 610, which, in turn, induce alternating currents in cable 642.

The communications modem described herein may interface with temperature monitoring sensor equipment positioned inside the container or gas analysis equipment to monitor the environmental conditions inside the container. Humidity or pressure may also be monitored. Furthermore, control signaling and/or audio signals, and/or video signals and/or a combination thereof may be interfaced with the communications modem.

Once data from the internal equipment has been transmitted externally of the container it may be relayed onward using any of the commonly available wireless data transmission systems. For example, such wireless data transmission systems may be anyone of a mobile telephone modem, a Bluetooth® link, a ZigBee® link, and/or an RFID tag which may be interrogated at short range.

As discussed, the system of the present invention does not require preparation or attachment to the barrier surfaces so may be conveniently temporarily installed on either side of a barrier such as for example a container. A clamping, bonding or mounting method could easily be devised to achieve temporary attachment as will be familiar to those skilled in mechanical engineering. By using magnetic flux to communicate through a wall of a container, the integrity of the structure of the container is maintained thus removing the need for barrier penetration or any modification of the barrier.

Magnetic communication through metal is possible, but is largely dependent on the frequency of communication, the materials thickness and its electromagnetic properties. A wireless magnetic communication link may be established by placing magnetic transmit and receive coils with the appropriate circuitry on either side of the material boundary. In another embodiment of the present invention, a freight container comprising composite, layered materials may enclose a liquid cargo and the low frequency signaling system described herein will be equally applicable to this scenario.

In some embodiments of the present invention the channel losses achieved by low frequency signaling may be low enough to achieve electrical power transfer through the barrier. In some embodiments of the present invention a low level power transfer may be sufficient to power low power sensors or extend the deployment time of battery powered equipment optionally displaced within the freight container.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is

1. A through barrier communications system suitable for data communications through a barrier such as a freight container comprising:
at least one of a primary coil and primary coupling core; and
at least one of a secondary coil and secondary coupling core for forming a magnetic flux circuit, wherein said at least one of primary and secondary coil passes electromagnetic signals with acceptable losses from one side of a barrier to another by means of low frequency electromagnetic signals and said composite barrier comprises at least one electrically conductive layer and at least one electrically insulating layer.

2. A through barrier communications system according to claim 1, wherein said electrically conductive layer has a conductivity greater than 2 S/m²

3. A through barrier communications system according to claim 1, wherein said electrically insulating layer has a conductivity less than 0.001 S/m²

4. A through barrier communications system according to claim 1, wherein said electromagnetic signals comprise a carrier signal that is modulated to represent data.

5. A through barrier communications system according to claim 4, wherein said electromagnetic signals received in the secondary coil are de-modulated to recover transmitted data.

6. A through barrier communication system according to claim 4, wherein said electromagnetic signals have an alternating frequency of less than 5 kHz.

7. A through barrier communication system according to claim 1, wherein at least one of the primary coupling coil and secondary coupling coil is arranged with its axis of symmetry orthogonal to the plane of the barrier.

8. A through barrier communication system according to claim 1, wherein at least one of the primary coupling coil or secondary coupling coil is arranged with its axis of symmetry orthogonal to the plane of the barrier.

9. A through barrier communication system according to claim 1, wherein the at least one of the primary coupling coil and secondary coupling coil is mounted co-centric around an elongate protrusion access point of a cable feed-through flange.

10. A through barrier communication system according to claim 1, wherein the at least one of the primary coupling coil or secondary coupling coil is mounted co-centric around an elongate protrusion access point of a cable feed-through flange.

11. A through barrier communication system according to claim 9 or 10, wherein said access point comprises a cable gland feeding at least one cable from said first side to said second side of composite barrier.

12. A through barrier communication system according to claim 1, wherein the at least one of primary coupling coil is separated and aligned mostly congruent with the at least one of secondary coupling coil.

13. A through barrier communication system according to claim 9 or 10, wherein said access point comprises a flange of an electrically non-conductive material.

14. A through barrier communication system according to claim 1, wherein the at least one primary core comprises at least two sub-sections.

15. A through barrier communication system according to claim 1, wherein the at least one secondary core comprises at least two sub-sections.

16. A through barrier communication system according to claim 14, wherein at least said two sub-sections of at least one of primary core can be assembled forming a unitary core.

17. A through barrier communication system according to claim 15, wherein at least said two sub-sections of at least one of secondary core can be assembled forming a unitary core.

18. A through barrier communication system according to claim 16 or 17, wherein assembled at least two sub-sections of at least one of primary core and/or secondary core are arranged co-concentric around access point so that a protruding cable of said access point passes through the centre axis of said at least one coupling core.

19. A through barrier communication system according to claim 1 wherein at least one of said primary coupling core and second secondary core is formed of a material having a high magnetic permeability.

20. A through barrier communication system according to claim 1 wherein at least one of said primary coupling core and second secondary core is a toroidal core

21. A through barrier communication system according to claim 1 wherein at least one of said primary coil and secondary coil is formed over an air core, plastic core, ceramic core, or other non-magnetic forms.

22. A through barrier communication system according to claim 13, wherein electromagnetic signals are passed from said primary coil to said secondary coil via said flange.

23. A through barrier communication system according to claim 4, wherein said data is bi-directional.

24. A through barrier communication system according to claim 4, wherein said data is relayed to a data network system.

25. A through barrier communication system according to of 24, wherein said data network is any one of GSM, Bluetooth®, Zig Bee®, GPS, RFID, or a combination thereof.

26. A through barrier communication system of claim 4, wherein said data is relayed to other sensors.

27. A through barrier communication system according to claim 4, wherein said data is any one of control signaling, audio, video, power, sensory.

28. A through barrier communication system according to claim 1, wherein said composite barrier comprises a first and a second metallic layer separated by a non-metallic layer.

29. A through barrier communication system according to claim 1, wherein said composite barrier comprises a first and a second metallic layer separated by a metallic layer.

30. A through barrier communication system according to claim 1, wherein said composite barrier is a freight container.

31. A through barrier communication system according to claim 1, wherein said composite barrier is an aircraft hull.

32. A through barrier communication system according to claim 1, wherein said composite barrier is a surfboard hull.
